(19) United States
(12) Patent Application Publication
(10) Pub. No.: US 2006/0260599 A1
(43) Pub. Date: Nov. 23, 2006

(54) Barbecue grill with fuel storage bin

(76) Inventor: Dennis Butt, Oak Lawn, IL (US)

Correspondence Address: R. Elliott Halsey, Esq., Suite 3410, 10 South LaSalle Street, Chicago, IL, 60603, US

(21) Appl. No.: 11/133,734

(22) Filed: May 23, 2005

(51) Int. Cl. F24B 3/00; A47J 37/00

(52) U.S. Cl. 126/25 R; 126/283

(57) ABSTRACT

An outdoor barbecuing grill is connected to a charcoal storage bin. The storage bin can preserve up to twenty pounds of charcoal for ready use in grilling. The grill is a standard construct of a cooking chamber with a lid and having inside it a food grate positioned over a fuel holding grate, which is then positioned over an ash catcher. The cooking chamber is removable and attached to the storage bin on top. The storage bin has portions facilitating the ease of access to the charcoal, such as by scooping charcoal from the bin with a scoop. The scoop hangs from a hanger, which is below the door. The storage bin also has 4 functions. Drip frame for keeping water outside the storage bin. Inside barrier frame to allow charcoal from being excessively pushed out of doors opening. The door, which opens at a outward position. The door has two sidewalls to keep charcoal from falling off the door and on the ground. The basin floor which has two sides that angle outward and upward and plus it angles downward away from doors opening to keep charcoal from excessively pushing out of storage bin.

### BACKGROUND OF THE INVENTION

1. Field Of The Invention

This invention relates generally to barbecue and smoker grills and, in particular, to a combination barbecue and smoker grill that incorporates a bin mounted to the grill for storing solid fuel.

2. Description of the Related Art

Cooking grills include are designed for either cooking foods by direct heating, generally referred to as barbecue grills, and cooking food items by indirect heating and smoking, generally referred to as smokers. In both types of grills, a cooking chamber typically is mounted upon a support structure, such as a pedestal or cart assembly. A lower portion for holding a fuel source is usually mounted to the support structure. A lid accompanies the storage bin and grill, and is formed to cooperate with the cooking chamber and lower portion to form a cooking enclosure. The cooking enclosure is configured for placing various food items therein, such as upon a grate or other cooking surface that rests within a lower region of the cooking chamber.

In a typical barbecue grill, the fuel source is usually charcoal briquettes or wood pieces. The fuel is the heat source and is burned below the cooking surface of the grill for heating the cooking chamber. Various food items placed on the grate are then heated to a sufficient temperature.

In a typical smoker grill, an enclosure called a firebox maintains a fire for smoldering wood therein, serving as an indirect source for heating food on the grate. The firebox is typically arranged adjacent to or underneath the cooking enclosure. The smoke and heat produced within the firebox enter the cooking chamber for smoking the food items placed on the grate.

For those who especially enjoy barbecuing, using solid fuels is often not the choice for grilling. Many people often choose a barbecue grill that uses a cooking gas such as propane as a fuel source. This is generally because of a perceived lack of ease of use of grills employing solid fuels. A major factor causing this perception among grilling enthusiasts is that the solid fuels used in barbecuing and smoking can be problematic in their storage around the home. Usually such fuels are stored outside of a home, for example, in a garage or shed. However, unless the fuel is used relatively soon after initial storage, the fuels can absorb water from the ground and out of the air. The result is a damp fuel source, which will not ignite without a generous amount of an accelerant, such as charcoal lighter fluid. A great amount of the accelerant usually causes foods to have the flavor of the accelerant. This is because the moisture can retard the combustion of the accelerant, leaving residual accelerant in the cooking chamber, even after a significant portion of the accelerant combusts.

Additionally, charcoal briquettes produce charcoal dust that collects on the clothing and hands of the user as the charcoal is loaded into the grill for burning. A person always gets dirty when using charcoal. For those grilling enthusiasts who regularly choose to employ solid fuels, there exists a need for a grilling accessory that imparts ease in the storage and transfer of fuel to the grill, without touching the fuel. A need exists to allow the user to avoid using his hands at all.

Therefore, there is a need for providing improved grills and smokers that address the shortcomings of the prior art.

### BRIEF SUMMARY OF THE INVENTION

### BRIEF DESCRIPTION OF THE SEVERAL VIEWS OF THE DRAWINGS

FIG. 1 is a front view illustrating the grill.

FIG. 2 is a front view of the door in the open position.

FIG. 3 is a view in section illustrating the grill from the rear.

FIG. 4 is a view in section illustrating the grill from the front

FIG. 5 is a view in section illustrating the grill from the side.

FIG. 6 is a front view of the door in the closed position.

Numerous other embodiments and objects will be evident from the description below.

### DETAILED DESCRIPTION OF THE INVENTION

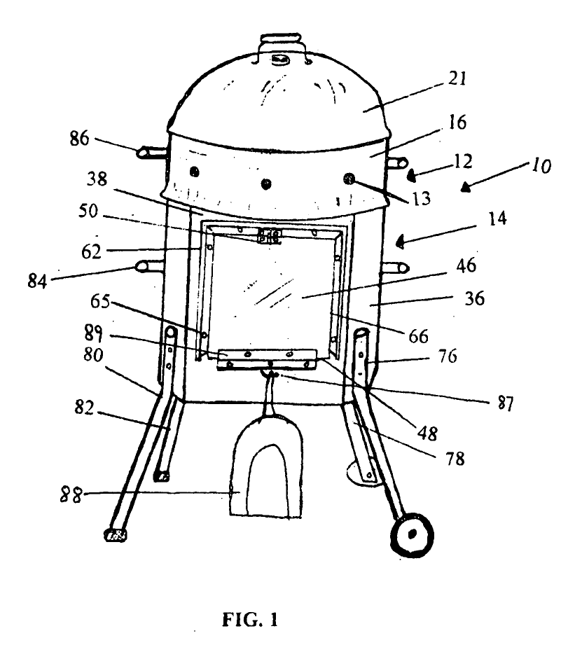

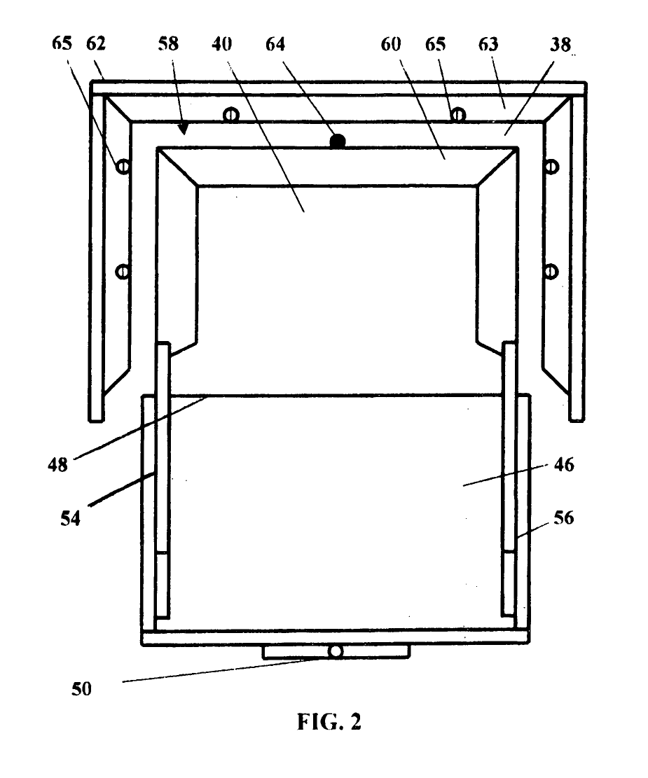

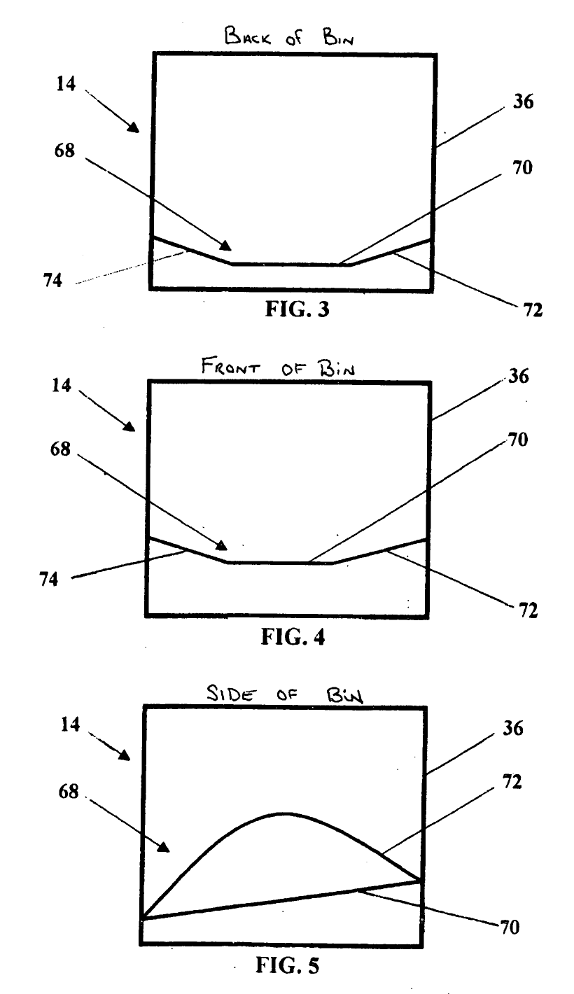

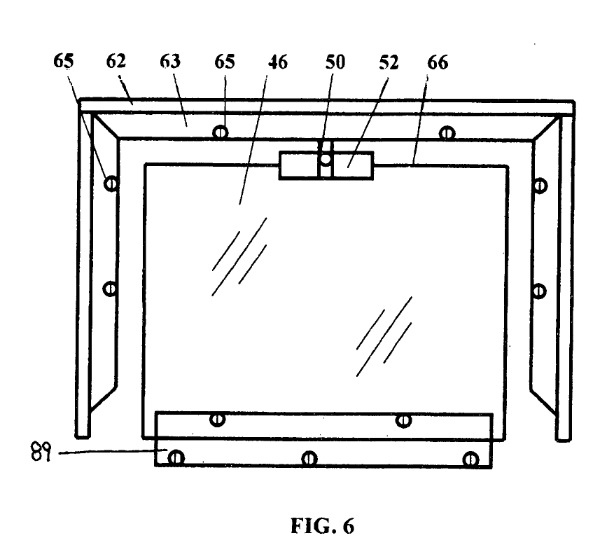

As shown in FIG. 1, the invention is a grill 10 consisting of a cooking chamber 12 and a storage bin 14. The cooking chamber 12 has a surrounding sidewall 16, which is generally circular. The surrounding sidewall 16 has an inner surface and an outer surface, and portions defining air holes 13 for ventilation in the cooking process. In the preferred embodiment, the cooking chambers 12 diameter is approximately 14.5 inches to 22.5 inches. The cooking chamber 12 may be another shape, such as the sort typically utilized in grilling. For example, a square, rectangular, or other polygonal shape in which the opposing edges of smaller sidewalls are joined together in sequence to form a larger surrounding wall (not shown).

A lid 21 is mountable onto an upper portion of the surrounding sidewall 16, thereby forming the cooking chamber 12. Also the lid 21 maybe mountable on the sidewalls of the storage bin 14 when cooking chamber 12 is not mounted on top of storage bin 14. The lid 21 may have vent holes as is standard in grill lids, in order to provide ventilation for the cooking process. The vent holes are usually adjusted by a rotating plate movably fixed to a grill 10 at the center of the plate, so that when the plate is rotated, the vent holes are revealed. Oxygen is permitted to enter the cooking chamber 12 in order to promote and maintain burning, and combustive air-borne byproducts are exhausted from the cooking chamber 12. In this way, the grill 10 performs the cooking process without the build-up of carbon-based combustive byproducts has on the food.

The cooking chamber 12 a standard food grate for supporting food located adjacent to the lid 21 in the cooking chamber 12. The food grate extends across the cooking chamber 12. A fuel grate for supporting a fuel source is located in the cooking chamber 12 underneath the food grate. Generally, in grilling the solid fuel source utilized is charcoal briquettes, wood chips, and hunks of wood. The preferred embodiment uses standard charcoal grilling briquettes employed in outdoor grilling, but variations may include wood chips and wood hunks used in smoking.

Also inside the cooking chamber 12 is an ash collection pan positioned underneath the fuel grate. The collection pan has a floor and a surrounding pan wall. As the charcoal burns to ash, smaller bits of burning fuel and combustive byproducts from the food and fuel collect on the floor. The collection pan has handles for grasping and lifting the collection pan off the cooking chamber 12. In order to dispose of byproducts after the grill 10 is used. The cooking chamber 12 is formed to rest on the top of storage bin 14

In the preferred embodiment, at least two support brackets secure the cooking chamber 12 onto the storage bin 14, and the storage bin 14 is located underneath the cooking chamber 12. The support braces (not shown) are fixed onto the outer surface of the cooking chamber 12 surrounding sidewall 16 and the outer sidewall of storage bin 14. It is contemplated that the invention may be practiced by associating the storage bin 14 and the grill 10 in other orientations. For example the invention may be practiced by laterally connecting the storage bin 14 to the grill 10. The invention contemplates that the fuel used for grilling is stored for ready use in immediate and a close association to the grill 10. In other words, the fuel is preserved in a safe and proper state for convenient use in grilling. The orientation of the grill 10 and the storage bin 14 is generally limited by the type and manner of exhaust used in the grilling process.

The storage bin 14 has a barrel 36 with a panel 38. The panel 38 is a planar side, which is the front of the storage bin 14 with portions defining an opening 40, and has an inner surface and an outer surface. Preferably, the barrel 36 is made from steel or similar rigid metal. The steel is formed to be heat-resistant.

A door 46 for covering the opening 40 is attached with a hinge 89 to the outer surface of the panel 38. The hinge 89 is attached to the panel at a bottom edge area 48 of the opening. The door opens outwardly by pivoting on the hinge. Preferably the door 46 measures about six inches by six inches (6″×6″) through ten inches by ten inches (10″×10″). The door 46 has a lock 50 for being secured in a closed position. The lock 50 has a portion for grasping 52, which can serve as a handle for the door 46.

Door sidewalls 54 and 56 are opposingly attached substantially parallel to each other and perpendicular to the door 46. The door sidewalls 54 and 56 are attached approximately three-fourths of an inch (¾″) inwardly of the respective edges of the door 46. The door sidewalls 54 and 56 extend approximately two and one-half inches (2½″) outwardly from the door 46 and longitudinally along substantially the entire length of the door 46.

The door sidewalls 54 and 56 function as barriers to stop pieces of the charcoal from falling out of the storage bin 14. The bin 14 may be filled full of charcoal to an extent at which individual pieces of the fuel pile above the opening 40. If the charcoal pieces spill out of the storage bin 14, through the opening 40 and onto the door 46, then they will be stopped from falling further to the ground. This is because the door sidewalls 54 and 56 will prohibit further movement of the pieces laterally off of the door 46 and onto the ground. The door sidewalls 54 and 56 function to keep charcoal from landing on a clean outdoor surface, thereby discoloring the surface or becoming wet.

A inside door barrier frame 58 is attached to the inner surface of the panel 38. The barrier frame 58 extends into the storage bin 14 are approximately five inches (5″) in the preferred embodiment, although greater and lesser distances are possible. The frame 58 extends along both lateral sides and a top side of the door opening 40. A top surface panel 60 of the frame 58 extends inwardly and angled downwardly into the storage bin 14. The sides of inside door barrier frame 58 are angled inwardly to keep solid fuel to be stuck on the sides of inside door barrier frame 58.

An outside door drip frame 62 is attached to the outer surface of the panel 38. The drip frame 62 is attached substantially perpendicular to the outer surface of panel 38, extending approximately three-fourths of an inch (¾″) outwardly from the storage bin 14. The drip frame 62 extends substantially entirely around sides and topside of the opening 40. The drip frame 62 is connected to the outside of panel 38 around door opening 40 by a rim portion of the frame 62 being bent longitudinally in half substantially perpendicular. A series of rivets or bolts 65 fasten the drip frame 62 to the panel 38. A hole 64 for the door lock 50 is centered on the topside of the outside drip frame 62 in the preferred embodiment, but other locking methods may be implemented in this invention, which could avoid the need of the hole 64 along the topside.

The outside door drip frame 62 prohibits water from entering the storage bin 14, when the door 46 is in an open or a closed position as shown in the Figures. The outside door drip frame 62 functions to ensure that the fuel in the storage bin 14 is kept dry for use. When the door 46 is closed, a seam 66 forms between the door 46 and the panel 38. The drip frame 62 physically repels any moisture that would fall onto the seam 66 from entering the storage bin 14. Also, the drip frame 62 extends around the door 46 sides in order to prohibit water that would splash from lateral directions from entering the storage bin 14 through the seam 66 between the panel 38 and the door 46 and dampening the fuel. When the door 46 is in the open position, the drip frame 62 stops moisture from landing on the opened door 46 and flowing inwardly to the storage bin 14 when the door 46 is open or closed thereafter.

A fuel collection basin 68 inside the storage bin 14 has a substantially horizontal basin floor 70 and at least two basin sidewalls 72 and 74 connected to the perimeter of the basin floor 70. The basin sidewalls 72 and 74 are beveled outwardly and upward from the basin floor 70. In the preferred embodiment, the basin sidewalls 72 and 74 are angled outwardly and upward at approximately zero to seventy degrees (0 to 70°) relative to the substantially horizontal basin floor 70. The basin floor 70 is a plate which is angled downward approximately zero to seventy degrees (0° to 70) from doors opening 40 to the back of the inside of storage bin 14. Angle bends along opposing sides to form the beveled sidewalls 72 and 74.

The basin sidewalls 72 and 74 are designed angled in order to aim charcoal 20 briquettes toward the basin floor 70. The charcoal briquettes loaded into the bin 14 contacts the basin sidewalls 72 and 74 and are channeled downwardly to the floor 70 by the basin sidewalls 72 and 74. The force of gravity acting downwardly on the charcoal pulls each briquette downwardly, until the briquette contacts the basin sidewalls 72 and 74. Once in contact with the basin sidewalls 72 and 74, the briquette moves inwardly and downwardly toward the basin floor 70 away from door opening 40. The storage bins 14 capacity is for approximately twenty pounds (20 lbs.) of charcoal briquettes depends on size of storage bin 14 that is made.

In an alternative embodiment not shown, the storage bin 14 may additionally have a loading ramp for receiving the charcoal that is loaded into a collection basin. The ramp loading has a first end and a second end. The loading ramp is connected to a floor of the basin. The first end is secured to a bottom lip of the doors opening. The second end is secured to the collection basin.

The floor 70 declines from the opening 40 toward the storage basin floor 70. In the preferred embodiment, the floor 70 declines approximately zero to six inches (0″ to 7″) from the first end to the second end. The charcoal briquettes are loaded into the storage bin 14 by pouring the charcoal y directly from a bag of charcoal, or by scooping the charcoal by using a tool. The charcoal is loaded by inserting through the top of storage bin 14 and onto the basin floor 70. The charcoal slides downwardly on the basin floor 70 and inwardly toward the storage bins 14 charcoal repository area. Likewise, if any charcoal or wood chips fall from the bag or scooping tool, then those solid fuel pieces will land on the door.

The preferred embodiment for the grill 10 has four legs 76, 78, 80 and 82. The legs 76, 78, 80 and 82 are attached to the side of the bin 14, through any standard means for substantially permanently securing metal parts together may be used, such as welding, screws, bolts, rivets, or wing nuts. Preferably, wing nuts are utilized to allow easy removal of the legs 76, 78, 80 and 82, for storage or transport of the grill 10.

Preferably, at least two legs have wheels. The wheels are located on the on the side legs. The wheels are important for moving the grill, especially when the bin is loaded with the wood chips or charcoal. The wheels spare a user from having to lift a heavy bag of charcoal every time the grill 10 is used.

The invention is a, esthetically pleasing, appearing as an outside piece of furniture. It maybe used with the grill 10 or just with the storage bin 14 itself to just store the charcoal or woodchips. It is contemplated that, in alternative embodiments, the grill 10 may have typical grilling accessories associated therewith. For example, a table surface for use in food preparation could be attached to the grill. At least two bottom braces are necessary for supporting the table. A first end of the brace is attached to a bottom surface of the table, and a second end of the brace is attached to the leg. The braces can be collapsed, and have leg stiffeners on each brace. The stiffeners impart sturdiness to the braces.

In the preferred embodiment, each of a pair of handles 84 and 86 is secured to opposing sides of the grill. The handles 84 and 86 are made from a material that significantly reduces, or completely prohibits, heat conduction. A user moves the grill 10 by grasping at least one of the handles 84 and 86, lifts, and rolls the grill 10 to a desired destination.

In further alternative embodiments not shown, it is contemplated that the invention may include any one or combination of accessories typically used in grilling. For example, the present invention may be equipped with accessories such as a receptacle attached to the outer surface for holding a container of charcoal lighter fluid. Also, a thermometer, heat and smoke vent, and ash catcher may be attached to the grill. Furthermore, a table may be attached to various places on the grill 10, such as the front panel or to the side of the barrel.

Finally, a hook used for hanging the scooping tool 88 may be attached to the storage bin 14. The hook 87 is attached to the panel 38 of the storage bin 14, below the door 46. The scoop 88 is necessary to avoid contact with the charcoal. In this way, the hands of a cook are kept free of charcoal soot while preparing the food on the grill 10. The hook 87 further serves as a means for prohibiting the door 46 from opening further than 75 degrees relative to the storage bin 14.

While certain preferred embodiments of the present invention have been disclosed in detail, it is to be understood that various modifications may be adopted without departing from the spirit of the invention or scope of the following claims.

1. A barbecue and smoker grill comprising:
(a) A cooking chamber; having a sidewall and a lower surface forming a bottom wall, a lid mounted on an upper rim of said sidewall to form said cooking chamber, a substantially horizontal food cooking grate supported at an upper portion of said cooking chamber adjacent said lid and extending across said chamber, a fuel grate for a solid cooking fuel supported underneath said food cooking grate, a collection pan supported underneath said fuel grate, said cooking chamber being substantially round in cross section, around said sidewall are said air vent that can be open or in closed position, there are said two handles that are opposite sides, mounted to said outside of sidewalls. Said lid can also be in relations with said fuel storage bin when grill is not connected making it use for both.
(b) A fuel storage bin connected to said cooking chamber in a fuel preserving relationship, said fuel storage bin comprising:
(1) A barrel having a surrounding barrel sidewall and a substantially front planar panel with portions defining an opening,
(2) A door covering said opening and hingedly attached to said barrels planar panel. said door having a pair of door sidewalls opposingly attached to said door. Said door also having a locking system;
(3) An inside door barrier frame attached to said barrel panel in proximity to said opening and extending inwardly into said repository;
(4) An outside door drip frame attached to said barrel panel in proximity to said opening substantially entirely around the perimeter of said opening and extending outwardly from said fuel storage bin;
(5) A solid fuel collection basin having a basin floor, and a plurality of basin sidewalls, which are angled outward and upward from basin floor are connected to said inside barrels sidewalls and planar panel. Said Basin sidewalls and said basin floor can be one solid piece or said basin sidewalls can be connected in any manner.

2. The grill of claim 1, wherein said basin sidewalls are beveled outwardly and upward from said floor.

3. The grill of claim 2, wherein said basin sidewalls are angled outwardly and upward at approximately zero to seventy degrees (0 to 70 degrees) relative to said basin floor.

4. The grill of claim 1, wherein said basin further includes a loading ramp for receiving a solid fuel, said ramp having a first end secured to said planar panel and a second end is secured to said barrels sidewalls to the back of barrel, said loading ramp declines from said opening toward said barrels sidewall to back of barrel resulting in an accumulation of said solid fuel in said storage bin.

5. The grill of claim 4, wherein said basin floor declines from said opening toward said barrels sidewall to the back of barrel at zero meaning straight to seven inches (0″ to 7″) from said first end to said second end.

6. The grill of claim 1, wherein said solid fuel collection basin extends substantially across said bins bottom.

7. The grill of claim 1, wherein said solid fuel collection basin extends entirely across said bins bottom.

8. The grill of claim 1, wherein said outside door drip frame extends approximately ¾ of an inch to two inches outwardly from said panel and said door opening. Said drip frame surrounds both said sides and top of opening and is connected to the said planar panel.

9. The grill of claim 1, wherein said lid includes an adjustable air damper.

10. The grill of claim 1, wherein at least one handle is attached to said lid.

11. The grill of claim 1, wherein at least one handle is attached to said outer surface of said barrel sidewall.

12. The grill of claim 1, wherein a pair of handles is secured to opposing sides of said outside barrel sidewall.

13. The grill of claim 1, wherein a plurality of support legs is attached to said outside of barrels sidewall.

14. The grill of claim 13, wherein said legs are removable.

15. The grill of claims 13 or 14, wherein at least two legs have wheels.

16. The grill of claim 1, wherein a receptacle for holding a cooking fuel accelerant attached to said outside barrels sidewall.

17. The grill of claim 1, wherein a hook for hanging a solid-fuel scooping tool is attached to said panel below said door and said opening.

18. The grill of claim 1, wherein said solid fuel is a carbon-based fuel.

19. The grill of claim 18, wherein said solid fuel are standard charcoal grilling briquettes.

20. The grill of claim 1, wherein said door sidewalls are opposingly attached to said door substantially parallel to each other and perpendicular to said door.

21. The grill of claim 20, wherein said door sidewalls extend approximately 2 and ½ inches outwardly from said door and longitudinally along substantially the entire length of said door.

22. The grill of claim 1, wherein said door measures about 6 inches by 6 inches through 10 inches by 10 inches square and is attached at the said bottom of the door and bottom of said doors opening.

23. The grill of claim 1, wherein said door has a lock for being secured in a closed position.

24. The grill of claim 23, wherein said a lock having portions defining a door handle.

25. The grill of claim 1, wherein said cooking chamber 12 is substantially round in cross section.

26. The grill of claim 1, wherein said grill 10 has a table attached for use in food preparation.

27. The grill of claim 1, wherein said inside barrier frame is attached to said inside planar panel around the top and sides of said door opening. It extends inwardly to repository of approximately five inches (5″) the sides are angled inwardly and the top is angled downwardly.

28. The grill of claim 1, wherein a said charcoal scoop is either plastic or metal used to scoop the charcoal from fuel storage bin.
